(19) United States
(12) Patent Application Publication
(10) Pub. No.: US 2014/0010299 A1
(43) Pub. Date: Jan. 9, 2014

(54) IMAGE PROCESSING APPARATUS AND ASSOCIATED METHOD

(71) Applicant: MStar Semiconductor, Inc., Hsinchu Hsien (TW)

(72) Inventors: Yi-Chin Huang, ChuPei (TW); Chia-Chiang Ho, ChuPei (TW); Yi-Shin Tung, ChuPei (TW); Pin-Ting Lin, ChuPei (TW)

(21) Appl. No.: 13/912,386

(22) Filed: Jun. 7, 2013

(30) Foreign Application Priority Data
Jul. 9, 2012 (TW) 101124672

(51) Int. Cl. H04N 7/36

(52) U.S. Cl. CPC H04N 19/00581
USPC 375/240.15

(57) ABSTRACT

An image processing apparatus including a processor and a memory is provided. The processor generates a target frame according to a reference frame stored in a storage region. The target frame has a first image data amount, and the reference frame has a second image data amount. The memory includes the storage region for storing the reference image and the target image. The processor has the target frame selectively overwrite a part of the reference frame. The capacity of the storage region is smaller than a sum of the first image data amount and the second image data amount, and is greater than the second image data amount.

This application claims the benefit of Taiwan application Serial No. 101124672, filed Jul. 9, 2012, the subject matter of which is incorporated herein by reference.

### BACKGROUND OF THE INVENTION

1. Field of the Invention

The invention relates in general to an image processing technique, and more particularly, to a technique for managing/utilizing memory in an image processing system.

2. Description of the Related Art

The number of mobile electronic devices providing complex image display functions for playing dynamic videos is ever-increasing. Image processing consumes a large amount of memory space. Held back by cost and power consumption considerations, a mobile communication device usually has a smaller memory capacity and a processor with less powerful performance compared to a fixed electronic apparatus (e.g., a desktop computer). If memory usage is not appropriately controlled, a mobile electronic device may crash or may be forced to shut down certain applications during playback of dynamic videos, causing user inconvenience.

Consider, for example, motion compensation mechanisms prevalent in dynamic image compression. When a target frame encoded in an inter-frame prediction is to be reconstructed by a decoder, in addition to the space for accommodating the reconstructed target frame, the memory needs to at the same time accommodate at least one reference frame serving as a basis for encoding and compression. In other words, a memory of an electronic device needs a capacity for accommodating data of at least two frames.

### SUMMARY OF THE INVENTION

To economize a memory capacity in an image processing procedure, the invention is directed to an image processing apparatus and associated method, which has a reconstructed target frame overwrite a region no longer used in a reference frame to lower a memory space requirement. The apparatus and method of the present invention is applicable to a mobile electronic device as well as various situations in need of reduced memory usage.

According to an embodiment the present invention, an image processing apparatus is provided. The apparatus includes: a processor, for generating a target frame according to a reference frame stored in a storage region; and a memory, including the storage region, for storing the reference frame and the target frame. The target frame has a first image data amount, and the reference frame has a second image data amount. The processor has the target frame selectively overwrite a part of the reference frame. The capacity of the storage region is smaller than a sum of the first image data amount and the second image data amount, and is greater than the second image data amount.

According to another embodiment of the present invention, an image processing method cooperating with a memory is provided. The memory includes a first storage region and a second storage region. The method includes steps of: storing a reference frame to the first storage region; generating a first part of a target frame according to the reference frame, and writing the first part into the second storage region; generating a second part of the target frame according to the reference frame, and writing the second part into the second storage region to overwrite a part of the reference frame. The overwritten part of the reference frame is associated with the first part of the target frame.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image processing apparatus according to an embodiment of the present invention.

FIGS. 2A to 2D are schematic diagrams of a utilization sequence of a memory according to an embodiment of the present invention.

FIG. 3 is a block diagram of an image processing apparatus according to an embodiment of the present invention.

FIG. 4 is a space allocation diagram of a memory capable of accommodating two reference frames.

FIG. 5 is a block diagram of an image processing apparatus according to another embodiment of the present invention.

FIG. 6 is a flowchart of an image processing method according to an embodiment of the present invention.

### DETAILED DESCRIPTION OF THE INVENTION

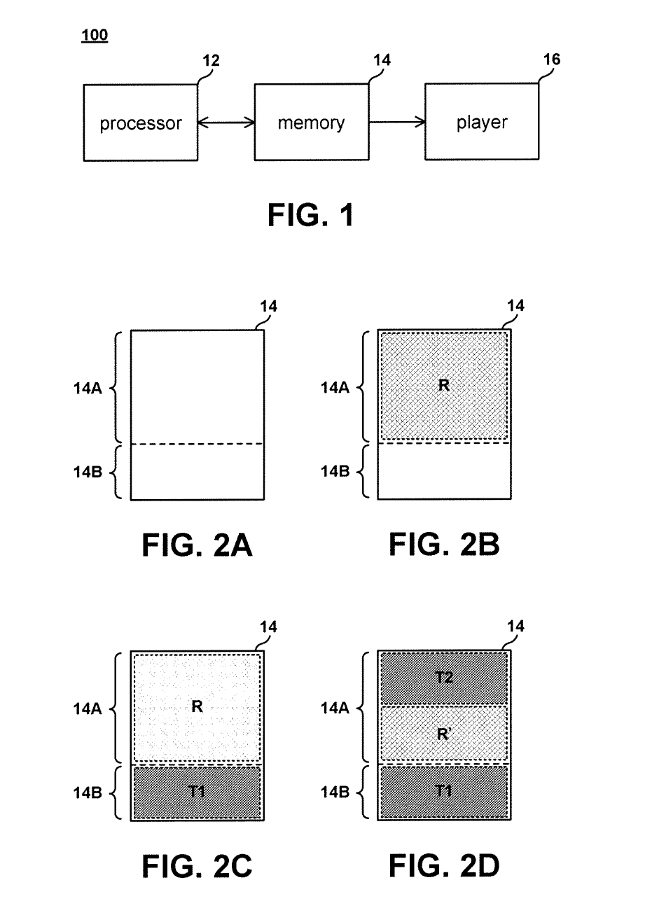

FIG. 1 shows an image processing apparatus 100 according to an embodiment of the present invention. The image processing apparatus 100 includes a processor 12, a memory 14 and a player 16. In practice, the image processing apparatus 100 may be integrated into various image processing systems or image processing playback apparatuses, or may be an independent unit. It should be noted that the player 16 is an optional element.

FIG. 2A shows a schematic diagram of an internal storage space of the memory 14. As shown in FIG. 2A, the memory 14 includes a first storage region 14A and a second storage region 14B. In practice, physical addresses and virtual addresses of the first storage region 14A and the second storage region 14B may be inconsecutive, and may comprise multiple free dispersed blocks. Furthermore, the memory 14 is not limited to a specific type, such as a dynamic random access memory (DRAM) or a static random access memory (SRAM).

In this embodiment, the first storage region 14A and the second storage region 14B are employed in different ways. In this embodiment, a target frame T is generated in the first storage region 14A, and similarly overwrites a part of a reference frame R. More specifically, when a target frame T is completely generated to serve as a reference frame R″ of another target frame T″, a memory controller 18 pushes down (copies) the target frame T to the second storage region 14B and a part of the first storage region 14A.

Thus, the target frame T″ corresponding to the reference frame R″ can be completely generated in the first storage region, and the player 16 is allowed to play all frames by regularly accessing the first storage region 14A.

That is to say, in practice, the player 16 does not need to support accessing and playing data from a virtual memory. It should be noted that, reference data required for the processor 12 for reconstructing the target frame T″ also appears in a non-overwritten part.

In this embodiment, the processor 12 sequentially generates image data of the target frame T″ row by row, from top to bottom. Referring to FIG. 2A, the image data of the target frame T″ is stored from top to bottom into the first storage region 14A according to a generated sequence, and the image data of the reference frame R″ is also stored into the second storage region 14B and a part of the first storage region 14A according to positions in the frame.

Accordingly, when the image data of the target frame T″ generated by the processor 12 starts overwriting the image data of the reference frame R″, the required image data of the reference frame R″ is located at a lower half of the frame, and the previously overwritten reference frame R″ is located at an upper half of the frame.

That is to say, no image data of the reference frame R″ is overwritten while the processor 12 is generating a first part T1″. Not until the processor 12 starts generating the second part T2″, can a part having a higher correlation with the first part T1″ and having a lower correlation with the second part T″ in the reference frame R″ be overwritten.

In an alternative embodiment, a target frame T is previously encoded according to a reference frame R, and thus the processor 12 reconstructs the target frame T according to the reference frame R. For example, the processor may be a decoder, which gradually reconstructs the target frame T in a unit of blocks according to motion vectors of the blocks in the target frame T relative to the reference frame R as well as the image data of the reference frame R.

The target frame T has a first image data amount, and the reference frame R has a second image data amount. In this embodiment, the capacity of the first storage region 14A equals or approximates the second image data amount (i.e., sufficient for accommodating the reference frame R), and the capacity of the second storage region 14B is smaller than the first image data amount. For example, the capacity of the second storage region 14B equals a half of the first image data amount (i.e., sufficient for accommodating a half of the target frame T). It should be noted that, the sizes of the reference frame R and the target frame T are not necessarily the same.

Referring to FIG. 2B, before the processor 12 starts generating the target frame T, the reference frame R is stored into the first storage region 14A. The processor 12 first generates the first part T1 of the target frame T (e.g., an upper half of the target frame T), and writes the first part T1 into the second storage region 14B.

Referring to FIG. 2C, in this example, the first part T1 exactly fills up the second storage region 14B. The processor 12 then starts generating a second part T2 of the target frame T (e.g., a lower half of the target frame T), and writes the second part T2 into the first storage region 14A to overwrite a part of the reference frame R. As shown in FIG. 2D, after being overwritten, only another part R′ remains in the first storage region 14A.

The overwritten part of the reference frame R relates to the first part T1 of the target frame T. Taking the upper half of the target frame T as the first part T1 for example, the overwritten part of the reference frame R may be an upper half of the reference frame R.

In general, a drastic difference does not exist between two temporally successive frames and between two blocks having the same position coordinates in two frames. Therefore, when encoding the upper half of the target frame T according to the reference frame R, the image data referred by the encoder is chiefly located at the upper half of the reference frame R.

Similarly, when encoding the lower half of the target frame T according to the reference frame R, the image data referred by the encoder is chiefly located at the lower half of the reference frame R. It can be concluded that the reference data needed by the processor 12 for reconstructing the second part T2 chiefly appears in the non-overwritten part R′.

Therefore, after the processor 12 generates the first part T1, overwriting the part having a higher correlation with the first part T1 and a lower correlation with the second part T2 in the reference frame does not noticeably affect the subsequent reconstruction of the second part T2.

As previously stated, a memory of a conventional solution needs to at the same time accommodate the reference frame R and the target frame T. In contrast, the memory 14 of the present invention may be designed to be smaller than a total size of the reference frame R and the target frame T to achieve a reduced memory usage.

In practice, the processor 12 may sequentially generate the image data of the target frame T. Therefore, the image data of the target frame T is first written into the second storage region 14B according to the generated sequence, and only has the newly generated image data sequentially overwrite the image data of the reference frame R when no more space is available in the second storage region 14B.

After completely reconstructing the target frame T, the memory 14 provides the target frame T to the player 16 for playback. It should be noted that, although the target frame T is separately stored in the physical memory as shown in FIG. 2D, the system or player may still regard the upper halves of the memories 14A and 14B as consecutive memories via a virtual memory to facilitate the access and playback processes.

In practice, if the player 16 is given adequate time and the reference frame R temporally appears before the target frame T, the player 16 may access the reference frame R from the memory 14 and play the reference frame R before the reference frame R is overwritten.

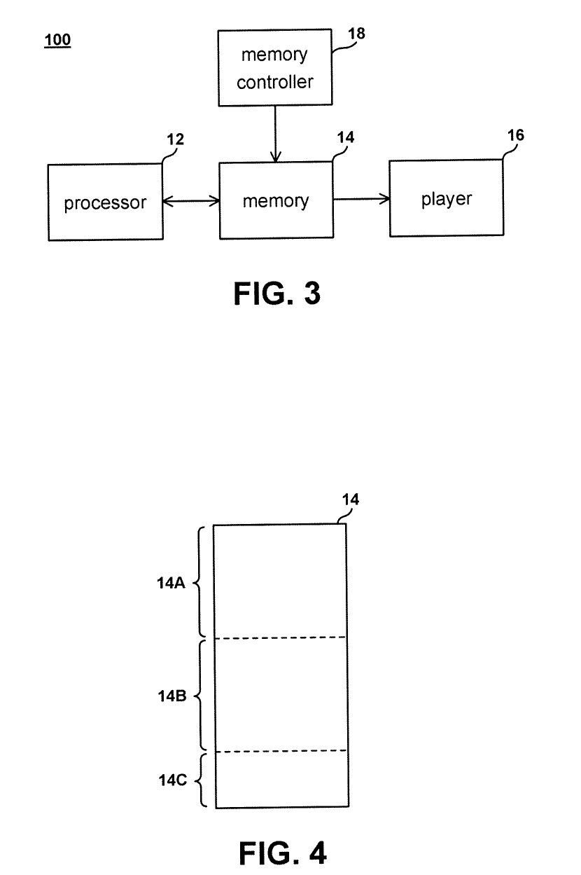

Referring to FIG. 3, in another embodiment, the image processing apparatus 100 may further include a memory controller 18. After the target frame T is completely generated, the memory controller 18 integrates the first part T1 and the second part T2 of the target frame T to the first storage region 14 to serve as a reference frame of another target frame. That is, the memory 14 is restored to a status as shown in FIG. 2B. Such approach lowers the complexity of the player 16 in accessing the memory 14, i.e., only the frame to be played needs to be regularly accessed from the first storage region 14A.

It should be noted that, the number of the reference frame is not limited to one. In practice, when the target frame is a predictive frame (P-frame) and the reference frame is an intra frame (I-frame), only one reference frame is needed. When the target frame is a bi-predictive frame (B-frame) and the reference frame is an I-frame, two reference frames are needed.

FIG. 4 shows an embodiment involving two reference frames. A memory 14 includes a first storage region 14A, a second storage region 14B and a third storage region 14C. The first storage region 14A and the second storage region 14B respectively store two reference frames, and the third storage region 14C stores a first part of a target frame.

After generating a second part of the target frame, a part that is less correlated with the second part of the target frame stored in the first storage region 14A or the second storage region 14B can be overwritten. It is seen that the capacity of the memory 14 is smaller than a total size of the two reference frames and the target frame, thereby achieving a reduced memory usage compared to a conventional solution.

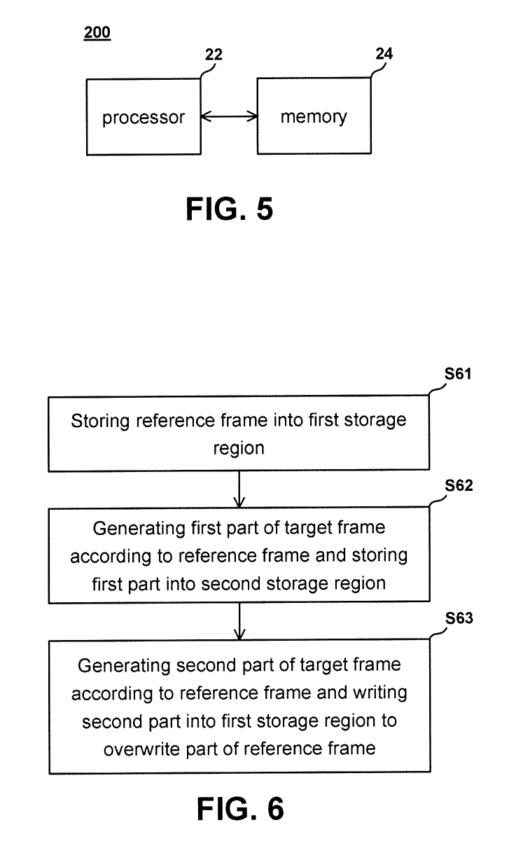

FIG. 5 shows an image processing apparatus 200 according to another embodiment of the present invention. The image processing apparatus 200 includes a processor 22 and a memory 24. In this embodiment, the processor 22 is an encoder for encoding a target frame according to a reference frame. The memory 24 includes a first storage region and a second storage region. Before the processor 22 starts generating the target frame, the reference frame is stored in the first storage region. Similarly, after generating a part of the target frame, the processor 22 may also have the generated part overwrite a part with less subsequent reference value in the reference frame in the memory 24. Details and a concept of this embodiment are identical to those shown in FIGS. 2A to 2D, and shall be omitted herein.

FIG. 6 shows a flowchart of an image processing method cooperating with a memory according to another embodiment of the present invention. The memory includes a first storage region and a second storage region. The method begins with Step S61 to store a reference frame into the first storage region. In Step S62, a first part of a target frame is generated according to the reference frame, and the first part is written into the second storage region.

In Step S63, a second part of the target frame is generated according the reference frame, and the second part is written into the first storage region to overwrite a part of the reference frame. The overwritten part of the reference frame relates to the first part of the target frame.

Various modifications (e.g., after the target frame is completely generated, the first part and the second part of the target frame are integrated to the first storage region to serve as a reference frame of another target frame) described in illustrations associated with the image processing apparatus 100 may also be applied to the image processing method in FIG. 6, and details thereof shall be omitted herein.

In conclusion, to achieve a reduced memory usage in an image processing procedure, an image processing apparatus and associated method is provided by the present invention. In the image processing apparatus and associated method of the present invention, a region no longer used in a reference frame is overwritten by a reconstructed target frame to lower a memory space requirement. The apparatus and method of the present invention is applicable to a mobile electronic device as well as various situations in need of a reduced memory usage.

While the invention has been described by way of example and in terms of the preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
a processor, configured to generate a target frame according to a reference frame stored in a storage region, wherein the target frame has a first image data amount, and the reference frame has a second image data amount; and
a memory, comprising the storage region, configured to store the reference frame and the target frame,
wherein the processor has the target frame selectively overwrite a part of the reference frame, and a capacity of the storage region is smaller than a sum of the first image data amount and the second image data amount, and is greater than the second image data amount.

2. The apparatus according to claim 1, wherein the storage region comprises a first storage region and a second storage region; a capacity of the first storage region approximates the second image data amount, and a capacity of the second storage region is smaller than the first image data amount; the reference image is stored in the first storage region, and the target frame is partly stored in the second storage region and partly selectively stored in the first storage region to overwrite a part of the reference frame; and the overwritten part of the reference frame is associated with the part of the target frame stored in the second storage region.

3. The apparatus according to claim 2, further comprising:
a memory controller, configured to integrate and store the target frame completely in the first storage region to serve as the reference frame of another target frame.

4. The apparatus according to claim 1, wherein the target frame is encoded according to the reference frame, and the processor reconstructs the target frame.

5. The apparatus according to claim 4, wherein the processor reconstructs the target frame according to a motion vector of the reference frame.

6. The apparatus according to claim 1, wherein the processor comprises a decoder, configured to decode the target frame according to the reference frame.

7. The apparatus according to claim 1, wherein the target frame is a P-frame (predictive frame) or a B-frame (bi-prediction frame).

8. The apparatus according to claim 1, wherein the overwritten part of the reference frame is provided for generating a part of the target frame before being overwritten.

9. The apparatus according to claim 1, wherein after the processor has the target frame selectively overwrite the part of the reference frame, the target frame is completely stored in the storage region.

10. An image processing method cooperating with a memory, the memory comprising a first storage region and a second storage region, the method comprising:
a) storing a reference frame into the first storage region;
b) generating a first part of a target frame according to the reference frame, and writing the first part into the second storage region; and
c) generating a second part of the target frame according to the reference frame, and writing the second part into the first storage region to overwrite a part of the reference frame; wherein the overwritten part of the reference frame is associated with the first part of the target frame.

11. The method according to claim 10, wherein the target frame has a first image data amount, the reference image has a second image data amount, a capacity of the first storage region approximates the second image data amount, and a capacity of the second storage region is smaller than the first image data amount.

12. The method according to claim 10, further comprising:
d) integrating and storing the target frame to the first storage region after the target frame is completely generated to serve as the reference frame of another target frame.

13. The method according to claim 10, wherein the target frame is encoded according to the reference frame, and step (b) and step (c) comprise reconstructing the target frame.

14. The method according to claim 13, wherein step (b) and step (c) respectively comprise reconstructing the first part and the second part of the target frame according to a motion vector corresponding to the reference frame.

15. The method according to claim 10, wherein step (b) and step (c) comprise decoding the target frame according to the reference frame.

16. The method according to claim 10, wherein the target frame is a P-frame (predictive frame) or a B-frame (bi-predictive frame).

17. The method according to claim 10, wherein the overwritten part of the reference frame is provided for generating a part of the target frame before step (c) overwrites the part of the reference frame.

18. The method according to claim 10, wherein the target frame is completely stored in the storage region after step (c) overwrites the overwritten part of the reference frame.
